(19) United States
(12) Patent Application Publication
(10) Pub. No.: US 2009/0050628 A1
(43) Pub. Date: Feb. 26, 2009

(54) Device to reuse disposable plastic shopping bags as trash bags

(76) Inventor: Julia G. Sullivan, (US)

Correspondence Address: Julia G. Sullivan, 81 Atlantic Avenue, Cohasset, MA, 02025, US

(21) Appl. No.: 11/894,419

(22) Filed: Aug. 21, 2007

(51) Int. Cl. B65D 25/14; B65D 90/00; B65F 1/06

(52) U.S. Cl. 220/495.1; 220/495.08

(57) ABSTRACT

A trash container allows disposable plastic shopping bags to be reused as trash bags. The trash container has at least two hooked projection members attached to the exterior of the trash container for removable attachment of the disposable shopping bags to the trash container. In an alternate embodiment, a resilient band with attached hooked projection members can be used on existing trash containers.

### BACKGROUND OF THE INVENTION

The present invention relates generally to a trash container that uses plastic shopping bags, and more particularly to a trash container that allows a user to easily and quickly reuse plastic shopping bags of different sizes.

Consumers frequently receive goods, such as groceries and other retail items, in plastic bags with handles. The plastic bags come in different sizes and configurations and are most often made of polyethylene. Currently, disposable retail shopping bags are problematic from an energy use and disposal perspective.

While previous attempts have been made to develop a trash-receiving shopping bag container, the use of prior art trash containers is cumbersome, time-consuming, and apt to have trash miss the liner and fall into the receptacle. For example, U.S. Pat. No. 6,772,903 shows a trash receptacle having a liner entirely within the trash receptacle, facilitating the falling of trash into the receptacle itself.

It is therefore an object of the present invention to provide a trash container that allows a user to reuse a plastic bag as a liner easily and quickly.

It is a further object of the present invention to provide an adaptor for an existing trash container that adapts the trash container to allow a user to quickly and easily use a plastic bag as a liner.

It is also an object of the present invention to provide a trash container that prevents trash from missing the liner falling into the receptacle.

It is an additional object of the present invention to provide a trash container that allows disposable plastic bags to be easily reused as trash bags, allowing decrease in both resource consumption and pollution.

### SUMMARY OF THE INVENTION

The present invention is a trash container comprising a bottom, a side wall and an open top for receiving trash. The trash container can by cylindrical, square, rectangle, or any of a variety of shapes. The exterior of the trash container includes a plurality of hooked projections. In the preferred embodiment, there are two hooked projections located opposite to each other, allowing the plastic bag to be inserted into the container, with its handles removably attached to the exterior of the trash container by fastening each handle over a hooked projection. In an alternate embodiment, hooks are attached to a stretchable band of rubber or similar material. The rubber band is placed around an existing trash container and allows it to be converted to use to receive shopping bags.

### BRIEF DESCRIPTION OF THE DRAWINGS

FIG. 1 is a perspective view of the trash container of the present invention.

FIG. 2 is a front view of the trash container of the present invention shown with a plastic bag.

FIG. 3 is a perspective view of an alternate embodiment of the trash container of the present invention.

FIG. 3 is a perspective view of an alternate embodiment of the present invention allowing existing trash containers to be converted to the use shown.

### DETAILED DESCRIPTION OF THE ILLUSTRATED EMBODIMENTS

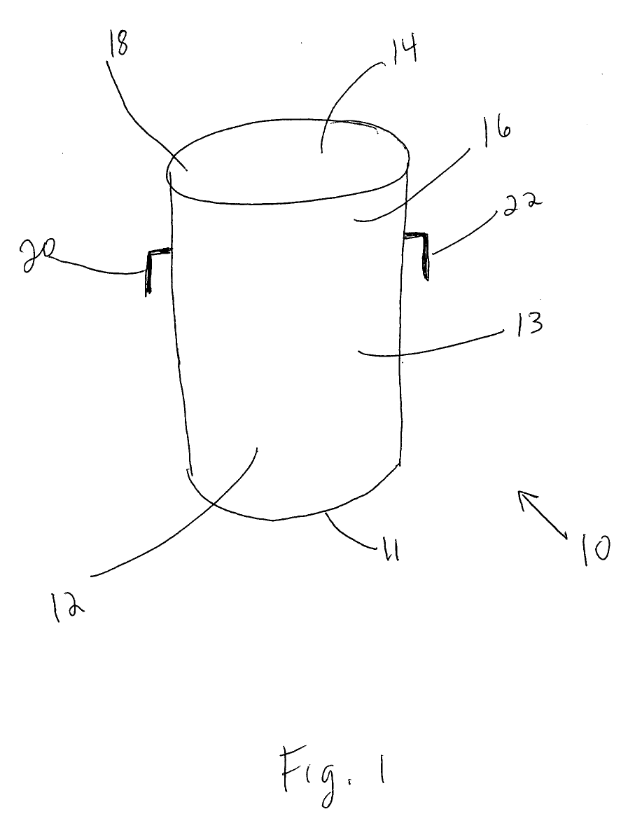

Referring to FIG. 1, a perspective view of the trash container 10 of the present invention is shown. The trash container is comprised of a hollow receptacle 12 having a bottom 11 and a sidewall 13. The sidewall 13, as shown in FIG. 1, has an inner wall 14, an outer wall 16, and an opening 18. At least two outwardly-directed hooked projections 20, 22 are attached to the trash container 10 on its outer wall 16. The trash container 10 may be cylindrical, rectangular, or any of a variety of shapes. The trash container 10 may be made of metal, plastic, or any of a variety of materials. Likewise, the hooked projections may be made of a variety of materials, and in a variety of shapes. The trash container may also have a lid, either attached with a hinge, or completely removable.

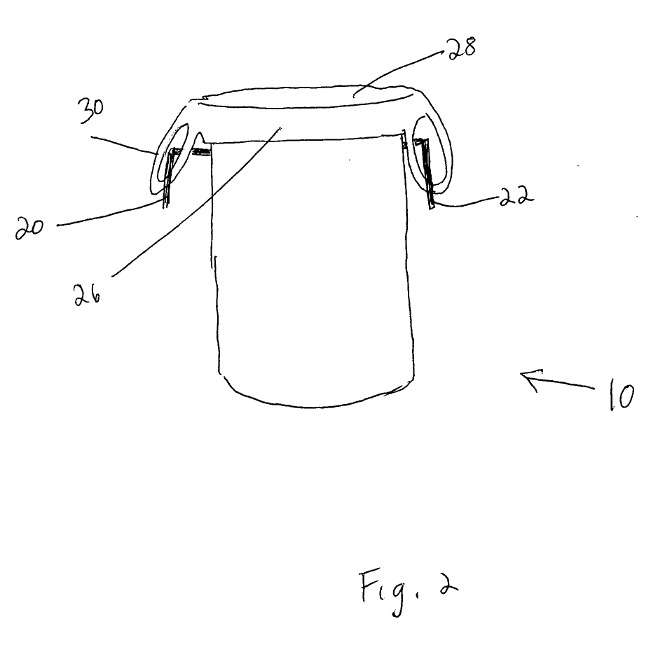

As shown in FIG. 2, a plastic bag 26 having opening 28 has been inserted into the trash container 10. One handle 30 of plastic bag 26 is shown hooked around outwardly-directed hooked projection 20. The second handle 32 of plastic bag 26 is shown hooked around outwardly-directed hooked projection 22. Each hooked projection member 20, 22 is comprised of a first portion that is attached to the exterior of said side wall and a second portion angled downward relative to said open top, each said hooked projection member being adapted to support a handle of a bag.

In an alternate embodiment, the trash container of the present invention is configured so that it can store bags that have been filled with trash while it is being used.

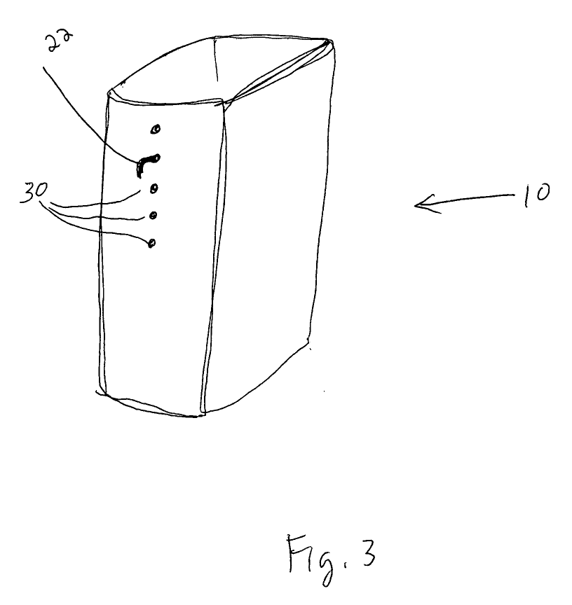

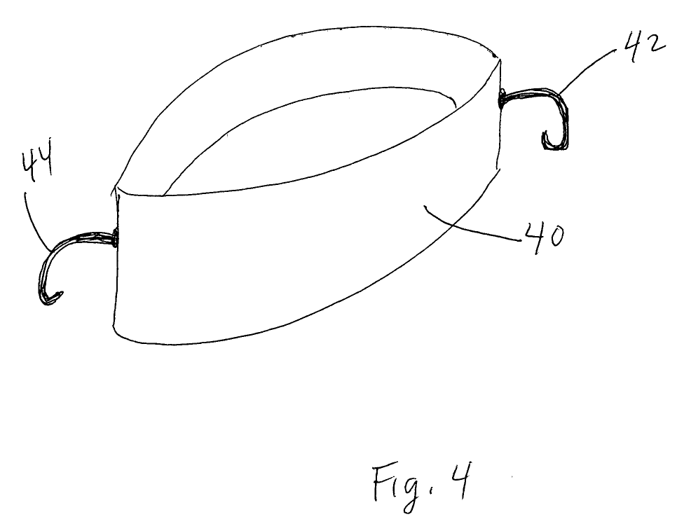

FIG. 3 shows a further embodiment of the present invention, where the trash container has a series of holes 30 in which hooked projection member 22 are removably inserted to allow use of different-sized plastic bags in the trash container. The hooked projection members may be screwed into the holes, or other methods of attachment may be used.

FIG. 4 shows an alternate embodiment of the present invention where a conventional trash container is adapted to accept a shopping bag for use as a trash bag. A resilient support band 40 is made of rubber, or similar material, that can be placed around a conventional trash receptacle. At least two projecting hooks 42, 44 are attached to the resilient support band. The projecting hooks are shaped to support a handle of a bag, and in the preferred embodiment, are opposedly attached to each other. In alternate embodiments, there can be more than two hooks, placed to accept bags of varying sizes.

What is claimed is:

1. A trash container comprising:
a bottom;
a side wall having an exterior and an interior;
an open top for receiving trash; and
a plurality of hooked projection members attached to said exterior of said side wall including a first hooked projection member opposedly attached to a second hooked projection member, and wherein each of said hooked projection members is comprised of a first portion attached to the exterior of said side wall and a second portion angled downward relative to said open top, each said hooked projection member being adapted to support a handle of a bag.

2. The trash container of claim 1 also comprising a lid being hingedly attached to said container.

3. The trash container of claim 1 wherein said bottom is circular in shape.

4. The trash container of claim 2 wherein said side wall is cylindrical in shape.

5. The trash container of claim 1 wherein said hooked projection members are removably attached to said exterior of said side wall.

6. The trash container of claim 1 wherein said side wall further comprises means for accepting said hooked projection members.

7. The trash container of claim 1 wherein said trash container further comprises means for storing at least one bag that has been filled with trash while a second bag is attached to said trash container for receiving trash.

8. A method of reusing a shopping bag as a trash bag, comprising:
a) obtaining a shopping bag having handles and an opening;
b) removably attaching said shopping bag to a container so that said shopping bag is inside said container, said opening is held open by said handles, and said handles are removably attached to the exterior of said container.

9. An apparatus for adapting a trash container to accept a shopping bag for use as a trash bag, said apparatus comprising:
a resilient support member for removable attachment to a trash receptacle; and
a plurality of hooked projection members attached to said resilient support member.

10. The apparatus of claim 9 wherein said resilient support member is comprised of an interior portion and a exterior portion, and each of said hooked projection members is comprised of a first portion attached to the exterior of said resilient support member and a second angled portion, each said second angled portion being adapted to support a handle of a bag.

11. The apparatus of claim 10 wherein said plurality of hooked projection members is further comprised of a first hooked projection member opposedly attached to a second hooked projection member.
